(19) United States
(12) Patent Application Publication
(10) Pub. No.: US 2026/0129289 A1
(43) Pub. Date: May 7, 2026

(54) IMAGE ACQUISITION SYSTEMS AND METHODS

(71) Applicant: ZHEJIANG DAHUA TECHNOLOGY CO., LTD., Hangzhou (CN)

(72) Inventors: Ming LIU, Hangzhou (CN); Wei WU, Hangzhou (CN); Dingxi LIU, Hangzhou (CN); Hongwu CHEN, Hangzhou (CN); Jianjun YANG, Hangzhou (CN); Wei XIE, Hangzhou (CN); Changyan GAO, Hangzhou (CN); Zhiyong XU, Hangzhou (CN)

(73) Assignee: ZHEJIANG DAHUA TECHNOLOGY CO., LTD., Hangzhou (CN)

(21) Appl. No.: 19/434,053

(22) Filed: Dec. 29, 2025

Related U.S. Application Data
(63) Continuation of application No. PCT/CN2024/089132, filed on Apr. 22, 2024.

(30) Foreign Application Priority Data
Jul. 7, 2023 (CN) 202310833723.9

(51) Int. Cl. H04N 23/60; H04N 23/13; H04N 23/90

(52) U.S. Cl. CPC H04N 23/665; H04N 23/13; H04N 23/90

(57) ABSTRACT

A method and system for image acquisition may be provided. A first exposure duration of a first image sensor and a second exposure duration of each of at least one second image sensor may be obtained. For each second image sensor, a synchronization time difference between the first image sensor and the second image sensor may be determined based on an exposure duration difference between the first exposure duration and the second exposure duration of the second image sensor, and first image data and second image data from the first image sensor and the second image sensor may be acquired by sending synchronizing signals to the first image sensor and the second image sensor based on the synchronization time difference. A target image of the target scene may be generated based on the first image data and the second image data of each second image sensor.

### CROSS-REFERENCE TO RELATED APPLICATIONS

This application is a continuation of International Application No. PCT/CN2024/089132, filed on Apr. 22, 2024, which claims priority of Chinese Patent Application No. 202310833723.9 filed on Jul. 7, 2023, the contents of each of which are incorporated herein by reference.

### TECHNICAL FIELD

The present disclosure relates to systems and methods for image acquisition, and in particular, to systems and methods for image acquisition using multiple image sensors.

### BACKGROUND

Currently, in order to obtain images with improved quality, a plurality of image sensors are usually used to collect image data simultaneously, and the image data from the image sensors is fused to generate the final image. For example, infrared light and visible light are detected via different image sensors, respectively, to obtain an infrared light image and a color image. Then, the color image and the infrared light image are fused to generate an image with high quality (e.g., high brightness). In this way, a relatively high quality image can be obtained even in low illumination.

### SUMMARY

According to an aspect of the present disclosure, a method for image acquisition may be provided. The method may be implemented on a computing device having at least one processor and at least one storage device. The method may include obtaining a first exposure duration of a first image sensor and a second exposure duration of each of at least one second image sensor. The first image sensor and the at least one second image sensor may be configured to shoot a target scene with different exposure durations. The method may also include, for each of the at least one second image sensor, determining a synchronization time difference between the first image sensor and the second image sensor based on an exposure duration difference between the first exposure duration and the second exposure duration of the second image sensor, and acquiring first image data and second image data from the first image sensor and the second image sensor, respectively, by sending synchronizing signals to the first image sensor and the second image sensor based on the synchronization time difference. The synchronization time difference may be smaller than the exposure duration difference. The method may further include generating a target image of the target scene based on the first image data of the first image sensor and the second image data of each second image sensor.

In some embodiments, the synchronization time difference may be equal to half of the exposure duration difference.

In some embodiments, for each of the at least one second image sensor, a difference between start exposure times of the first image sensor and the second image sensor may be smaller than the exposure duration difference.

In some embodiments, the first image sensor may be configured to sense one of infrared light and color light in the target scene, and the at least one second image sensor may be configured to sense another of infrared light and color light in the target scene.

In some embodiments, to generate a target image of the target scene based on the first image data of the first image sensor and the second image data of each second image sensor, the method may include performing a noise reduction operation on the first image data to generate denoised first image data. The method may also include performing a noise reduction operation on the second image data of each second image sensor to generate denoised second image data. The method may include generating third image data by fusing the denoised first image data and the denoised second image data of each second image sensor. The method may further include generating the target image by enhancing the third image data.

In some embodiments, the first image sensor may be determined from multiple image sensors with different exposure durations by performing the following operations. The method may include, for each of the multiple image sensors, obtaining historical image data captured by the image sensor, and determining relative position information of the image sensor to a region of interest (ROI) in the target scene based on the historical image data. The method may further include determining the first image sensor from the plurality of sensors based on the relative position information of each of the multiple image sensors to the ROI.

In some embodiments, the first image sensor may be determined from multiple image sensors with different durations by performing the following operations. The method may include, for each of the multiple image sensors, determine an exposure duration difference between an exposure duration of the image sensor and an exposure duration of each of the remaining image sensors of the multiple image sensors, and determine a total exposure duration difference corresponding to the image sensor by summing the exposure duration difference between the exposure duration of the image sensor and the exposure duration of each of the remaining image sensors of the multiple image sensors. The method may further include determining the first image sensor based on the total exposure duration differences corresponding to the multiple image sensors.

In some embodiments, the first image sensor may have a first pixel array that includes N first rows. The at least one second image sensor may include a second image sensor having a second pixel array that includes M second rows. The synchronizing signals may include N first synchronizing signals corresponding to the N first rows and M second synchronizing signals corresponding to the M second rows.

In some embodiments, N may be equal to M, and a transmission time difference between the first synchronizing signal of the i^{th} first row and the second synchronizing signal of the i^{th} second row may be equal to the synchronization time difference.

In some embodiments, N may be different from M, and the sending synchronizing signals to the first image sensor and the second image sensor based on the synchronization time difference may comprises the following operations. The method may include determining a proportionality coefficient based on N and M. The method may also include determining a corresponding relationship between the first rows of the first pixel array and the second rows of the second pixel array based on the proportionality coefficient. The method may further include sending the N first synchronizing signals and the M second synchronizing signals based on the corresponding relationship and the synchronization time difference.

In some embodiments, when N is smaller than M, each first row of the first pixel array may correspond to multiple second rows of the second pixel array, the count of the multiple second rows may be equal to the proportionality coefficient. When M is smaller than N, multiple first rows of the first pixel array may correspond to one second row of the second pixel array, the count of the multiple first rows may be equal to the proportionality coefficient. A transmission time difference between the first synchronizing signal of the i^{th} first row and the second synchronizing signal of each second row corresponding to the i^{th} first row may be equal to the synchronization time difference.

According to another aspect of the present disclosure, a system for image acquisition may be provided. The system may include at least one storage device including a set of instructions and at least one processor. The at least one processor may be configured to communicate with the at least one storage device. When executing the set of instructions, the at least one processor may be configured to direct the system to perform one or more of the following operations. The system may obtain a first exposure duration of a first image sensor and a second exposure duration of each of at least one second image sensor. The first image sensor and the at least one second image sensor may be configured to shoot a target scene with different exposure durations. For each of the at least one second image sensor, the system may determine a synchronization time difference between the first image sensor and the second image sensor based on an exposure duration difference between the first exposure duration and the second exposure duration of the second image sensor, and acquire first image data and second image data from the first image sensor and the second image sensor, respectively, by sending synchronizing signals to the first image sensor and the second image sensor based on the synchronization time difference. The synchronization time difference may be smaller than the exposure duration difference. Further, the system may generate a target image of the target scene based on the first image data of the first image sensor and the second image data of each second image sensor.

According to yet another aspect of the present disclosure, a system for image acquisition may be provided. The system may include an acquisition module, a determination module, and a generation module. The acquisition module may be configured to obtain a first exposure duration of a first image sensor and a second exposure duration of each of at least one second image sensor. The first image sensor and the at least one second image sensor may be configured to shoot a target scene with different exposure durations. The determination module may be configured to, for each of the at least one second image sensor, determine a synchronization time difference between the first image sensor and the second image sensor based on an exposure duration difference between the first exposure duration and the second exposure duration of the second image sensor, and acquire first image data and second image data from the first image sensor and the second image sensor, respectively, by sending synchronizing signals to the first image sensor and the second image sensor based on the synchronization time difference. The synchronization time difference may be smaller than the exposure duration difference. The generation module may be configured to generate a target image of the target scene based on the first image data of the first image sensor and the second image data of each second image sensor.

According to yet another aspect of the present disclosure, a non-transitory computer readable medium may be provided. The non-transitory computer readable medium may include at least one set of instructions for medical imaging. When executed by one or more processors of a computing device, the at least one set of instructions may cause the computing device to perform a method. The method may be implemented on a computing device having at least one processor and at least one storage device. The method may include obtaining a first exposure duration of a first image sensor and a second exposure duration of each of at least one second image sensor. The first image sensor and the at least one second image sensor may be configured to shoot a target scene with different exposure durations. The method may also include, for each of the at least one second image sensor, determining a synchronization time difference between the first image sensor and the second image sensor based on an exposure duration difference between the first exposure duration and the second exposure duration of the second image sensor, and acquiring first image data and second image data from the first image sensor and the second image sensor, respectively, by sending synchronizing signals to the first image sensor and the second image sensor based on the synchronization time difference. The synchronization time difference may be smaller than the exposure duration difference. The method may further include generating a target image of the target scene based on the first image data of the first image sensor and the second image data of each second image sensor.

According to yet another aspect of the present disclosure, a device for image acquisition may be provided. The device may include at least one processor and at least one storage device for storing a set of instructions. When the set of instructions may be executed by the at least one processor, the device performs the methods for image acquisition.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A is a schematic diagram illustrating an exemplary image acquisition system according to some embodiments of the present disclosure;

FIG. 1B is a schematic diagram illustrating an exemplary image acquisition device according to some embodiments of the present disclosure;

FIG. 2 is a schematic diagram illustrating exemplary hardware and/or software components of an exemplary computing device according to some embodiments of the present disclosure;

FIG. 3 is a block diagram illustrating exemplary processing device according to some embodiments of the present disclosure;

FIG. 4 is a flowchart illustrating an exemplary process for image acquisition according to some embodiments of the present disclosure;

FIG. 5 is a schematic diagram illustrating an exemplary exposure way of a first image sensor and a second image sensor during a conventional image acquisition process;

FIG. 6 is a schematic diagram illustrating an exemplary exposure way of the first image sensor and the second image sensor in FIG. 5 during an image acquisition process according to some embodiments of the present disclosure; and

FIG. 7 is a schematic diagram illustrating another exemplary exposure way of the first image sensor in FIG. 5 and another second image sensor during an image acquisition process according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items. The term “pixel” and “voxel” in the present disclosure are used interchangeably to refer to an element of an image.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

In the present disclosure, a representation of a subject (e.g., an object, a patient, or a portion thereof) in an image may be referred to as “subject” for brevity. Further, an image including a representation of a subject, or a portion thereof, may be referred to as an image of the subject, or a portion thereof, or an image including the subject, or a portion thereof, for brevity. Still further, an operation performed on a representation of a subject, or a portion thereof, in an image may be referred to as an operation performed on the subject, or a portion thereof, for brevity.

In some conventional image acquisition approaches, a plurality of image sensors are configured to shoot a target scene with a same exposure duration, that is, synchronizing signals are sent to the plurality image sensors at the same time. However, in some cases, since those sensors have different ambient light brightness and/or be configured to detect different types of light, they are suitable for different exposure durations and cannot operate in their optical status with the same exposure duration. Thus, an image obtained by fusing image data collected by the plurality of image sensors has a low clarity.

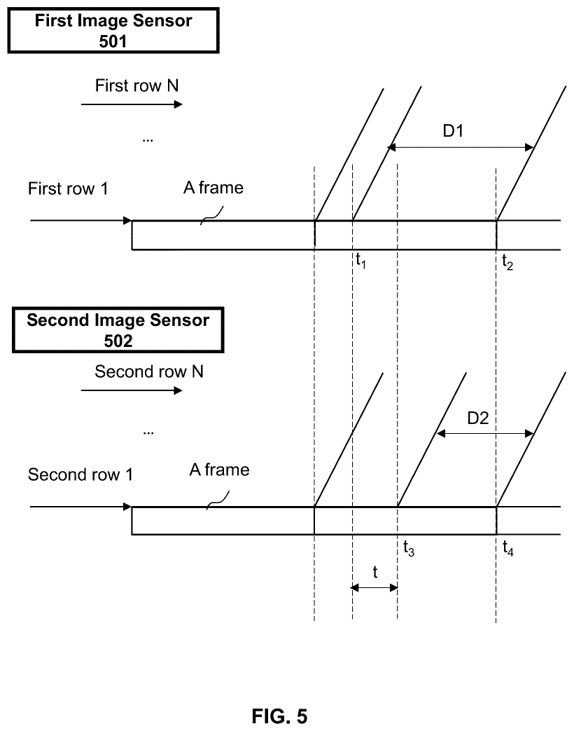

In some other conventional image acquisition approaches, when a plurality of image sensors shoot a target scene, each image sensor uses its optimal exposure duration to collect image data, and end exposure times of the plurality of image sensors are the same. In this case, a synchronization time difference between any two image sensors is equal to an exposure duration difference of the two image sensors. For example, FIG. 5 is a schematic diagram illustrating an exemplary exposure way of a first image sensor 501 and a second image sensor 502 during a conventional image acquisition process. As shown in FIG. 5, the first image sensor and the second image sensor are used to shoot a target scene with a first exposure duration D1 and a second exposure duration D2, respectively. The first exposure duration D1 and the second exposure duration D2 are different, and a difference between the first exposure duration D1 and the second exposure duration D2 is equal to t. The first image sensor has a first pixel array that includes N first rows, and the second image sensor has a second pixel array that includes M second rows. M is equal to N, and each first row corresponds to one second row. End exposure times t₂ and t₄ of the first image sensor and the second image sensor are the same, and a difference between start exposure times t₁ and t₃ of the first image sensor and the second image sensor is equal to t. Since a synchronization time difference between of the first image sensor and the second image sensor is equal to the difference between start exposure times of the first image sensor and the second image sensor, the synchronization time difference between of the first image sensor and the second image sensor is equal to the t. Within the duration/after the first image sensor start the exposure, only the first image sensor is exposing. Since the duration/is a continuous duration, it is more possible that obvious changes occur in the target scene (e.g., a moving object or an object with varying brightness occurs) in the duration t. If obvious changes occur in the duration 1, the imaging quality of the target scene is greatly reduced since the second image sensor is not exposing in the duration t.

Thus, it may be desirable to develop improved systems and methods for image acquisition using multiple image sensors, thereby improving the imaging quality.

An aspect of the present disclosure relates to systems and methods for image acquisition. The systems may obtain a first exposure duration of a first image sensor and a second exposure duration of each of at least one second image sensor. The first image sensor and the at least one second image sensor may be configured to shoot a target scene with different exposure durations. For each of the at least one second image sensor, the systems may determine a synchronization time difference between the first image sensor and the second image sensor based on an exposure duration difference between the first exposure duration and the second exposure duration of the second image sensor. The synchronization time difference is smaller than the exposure duration difference. Further, the systems may acquire first image data and second image data from the first image sensor and the second image sensor, respectively, by sending synchronizing signals to the first image sensor and the second image sensor based on the synchronization time difference. Then, the systems may generate a target image of the target scene based on the first image data of the first image sensor and the second image data of each second image sensor. In some embodiments, the synchronization time difference is equal to half of the exposure duration difference.

According to the methods and systems of the present disclosure, each image sensor can collect image data with its corresponding optimal exposure duration, so that each image sensor may collect clear image data. Moreover, by setting the synchronization time difference smaller than the exposure duration difference, the duration in which part of the image sensors are not exposing can be dispersed, thereby improving the clarity or accuracy of the target image. When the synchronization time difference is equal to half of the exposure duration difference, on the one hand, centers of the first exposure duration of the first image sensor and the second exposure duration of the second image sensor are coincide, which may facilitate to the fusion of the first image data and the second image data. On the other hand, when an ROI (e.g., a moving object or an object with changing brightness) occurs in the target scene, it is more like that the first image sensor and the second image sensor can collect image data of the ROI simultaneously, thereby improving the imaging quality with respect to the ROI. Therefore, compared with the conventional exposure ways, the exposure ways disclosed herein have an improved imaging quality, especially for moving objects and objects with changing brightness.

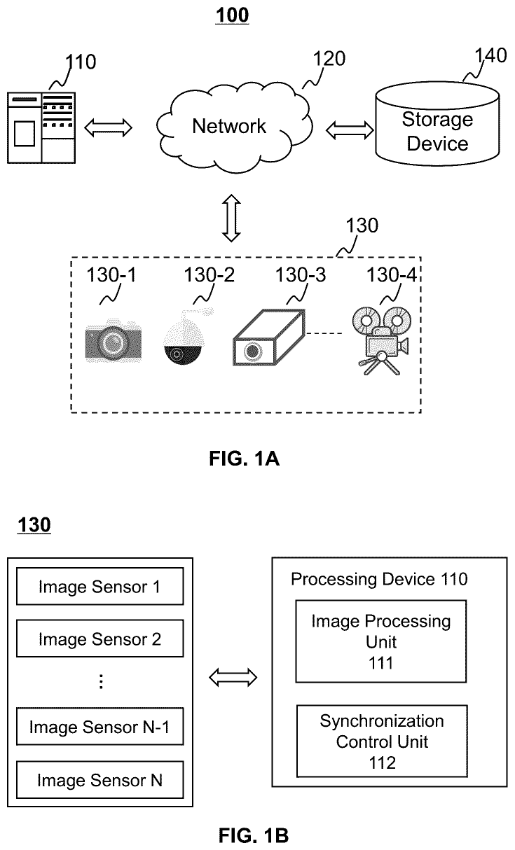

FIG. 1A is a schematic diagram illustrating an exemplary image acquisition system 100 according to some embodiments of the present disclosure. As shown in FIG. 1A, the image acquisition system 100 may include a processing device 110, a network 120, an image acquisition device 130, and a storage device 140. The image acquisition system 100 may be used to shoot images in various fields including, for example, photography, filming, monitoring, and detection.

The processing device 110 may process information and/or data relating to the image acquisition system 100 to perform one or more functions described in the present disclosure. For example, the processing device 110 may obtain image data collected by the image acquisition device 130, and generate an image based on the image data.

In some embodiments, the processing device 110 may be a single server or a server group. In some embodiments, the processing device 110 may be local to or remote from the image acquisition system 100. Merely for illustration, only one processing device 110 is described in the image acquisition system 100. However, it should be noted that the image acquisition system 100 in the present disclosure may also include multiple processing devices. Thus operations and/or method steps that are performed by one processing device 110 as described in the present disclosure may also be jointly or separately performed by the multiple processing devices. For example, if in the present disclosure the processing device 110 of the image acquisition system 100 executes both process A and process B, it should be understood that the process A and the process B may also be performed by two or more different processing devices jointly or separately in the image acquisition system 100 (e.g., a first processing device executes process A and a second processing device executes process B, or the first and second processing devices jointly execute processes A and B).

The network 120 may include any suitable network that can facilitate the exchange of information and/or data for the image acquisition system 100. In some embodiments, one or more components (e.g., the processing device 110, the image acquisition device 130) of the image acquisition system 100 may communicate information and/or data with one or more other components of the image acquisition system 100 via the network 120. For example, the processing device 110 may transmit synchronizing signals to the image acquisition device 130 via the network 120. In some embodiments, the network 120 may be or include a wired network, a wireless network (e.g., an 802.11 network, a Wi-Fi network), etc.

The image acquisition device 130 may be and/or include any suitable device that is capable of acquiring image data. Exemplary image acquisition device 130 may include a camera (e.g., a digital camera, an analog camera, an IP camera (IPC), etc.), a video recorder, a scanner, a mobile phone, a tablet computing device, a wearable computing device, an infrared imaging device (e.g., a thermal imaging device), or the like. In some embodiments, as shown in FIG. 1A, the image acquisition device 130 may include a digital camera 130-1, a dome camera 130-2, an integrated camera 130-3, a binocular camera 130-4, a monocular camera, etc. The image acquisition device 130 may include a plurality of image sensors. Exemplary image sensors may include a charge-coupled device, a complementary metal-oxide-semiconductor transistor (CMOS) image sensor, or the like.

In some embodiments, the processing device 110 may be part of the image acquisition device 130. For example, FIG. 1B is a schematic diagram illustrating an exemplary image acquisition device 130 according to some embodiments of the present disclosure. The image acquisition device 130 may include image sensors 1-N and processing device 110. The processing device 110 may include an image processing unit 111 and a synchronization control unit 112. The image sensors 1-N may be configured to collect image data. The image processing unit 111 may be configured to generate a target image of a target scene based on image data collected by the image sensors 1-N. The synchronization control unit 112 may be configured to send synchronizing signals to the image sensors 1-N. In some embodiments, the image processing unit 111 may obtain exposure durations of the image sensors 1-N, and direct, based on exposure durations of the image sensors 1-N, the synchronization control unit 112 to send synchronizing signals to the image sensors 1-N. The image sensors 1-N may collect the image data based on the synchronizing signals. In some embodiments, the image processing unit 111 and the synchronization control unit 112 may be integrated into a single component. The storage device 140 may store data and/or instructions. The data and/or instructions may be obtained from, for example, the processing device 110, the image acquisition device 130, and/or any other component of the image acquisition system 100. For example, the storage device 140 may store image data acquired by the image acquisition device 130 and/or images generated by the processing device 110. In some embodiments, the storage device 140 may store data and/or instructions that the processing device 110 (e.g., the processing device 110) may execute or use to perform exemplary methods described in the present disclosure. In some embodiments, the storage device 140 may include a mass storage device, a removable storage device, a volatile read-and-write memory, a read-only memory (ROM), or the like, or any combination thereof. In some embodiments, the storage device 140 may be implemented on a cloud platform.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the image acquisition system 100 may include one or more additional components and/or one or more components of the image acquisition system 100 described above may be omitted. For example, the image acquisition system 100 may include a terminal device. The images generated by the processing device 110 may be displayed on the terminal device. Additionally or alternatively, two or more components of the image acquisition system 100 may be integrated into a single component. A component of the image acquisition system 100 may be implemented on two or more sub-components.

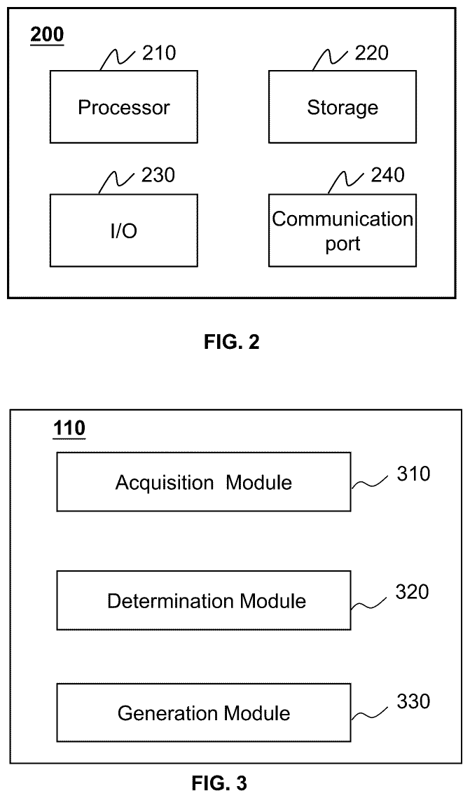

FIG. 2 is a schematic diagram illustrating exemplary hardware and/or software components of an exemplary computing device according to some embodiments of the present disclosure. In some embodiments, the processing device 110 may be implemented on the computing device 200. As illustrated in FIG. 2, the computing device 200 may include a processor 210, a storage 220, an input/output (I/O) 230, and a communication port 240.

The processor 210 may execute computer instructions (program code) and perform functions of the processing device 110 in accordance with techniques described herein. The computer instructions may include routines, programs, objects, components, signals, data structures, procedures, modules, and functions, which perform particular functions described herein. Merely for illustration purposes, only one processor is described in the computing device 200. However, it should be noted that the computing device 200 in the present disclosure may also include multiple processors, and thus operations of a method that are performed by one processor as described in the present disclosure may also be jointly or separately performed by the multiple processors.

The storage 220 may store data/information obtained from the processing device 110, the image acquisition device 130, the storage device 140, or any other component of the image acquisition system 100. In some embodiments, the storage 220 may include a mass storage device, a removable storage device, a volatile read-and-write memory, a read-only memory (ROM), or the like, or any combination thereof. In some embodiments, the storage 220 may store one or more programs and/or instructions to perform exemplary methods described in the present disclosure.

The I/O 230 may input or output signals, data, or information. In some embodiments, the I/O 230 may enable user interaction with the processing device 110. In some embodiments, the I/O 230 may include an input device and an output device.

The communication port 240 may be connected to a network (e.g., the network 120) to facilitate data communications. The communication port 240 may establish connections between the processing device 110 and the processing device 110, the image acquisition device 130, or the storage device 140. The connection may be a wired connection, a wireless connection, or combination of both that enables data transmission and reception.

It should be noted that the above description of the computing device 200 is merely provided for the purposes of illustration, and not intended to limit the scope of the present disclosure. For persons having ordinary skills in the art, multiple variations and modifications may be made under the teachings of the present disclosure.

FIG. 3 is a block diagram illustrating exemplary processing device 110 according to some embodiments of the present disclosure.

As shown in FIG. 3, the processing device 110 may include an acquisition module 310, a determination module 320, and a generation module 330. As described in FIG. 1A, the image acquisition system 100 in the present disclosure may also include multiple processing devices, and the acquisition module 310, the determination module 320, and the generation module 330 may be components of different processing devices.

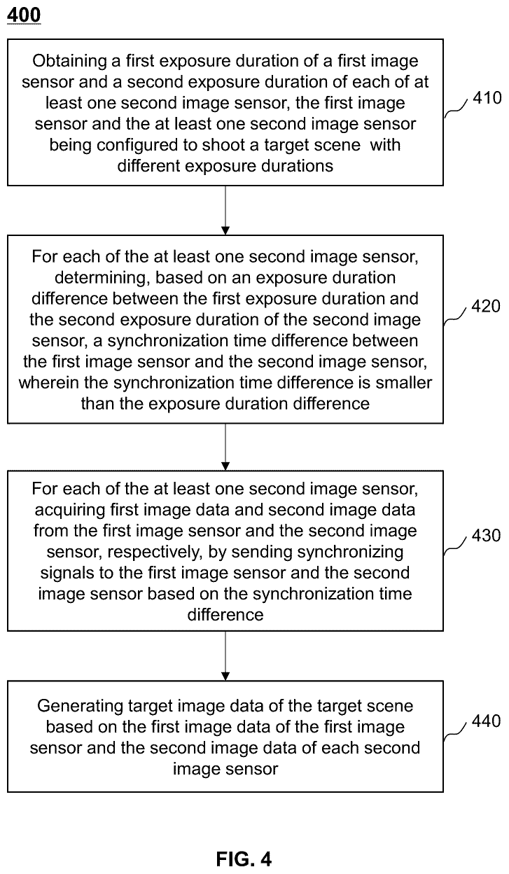

The acquisition module 310 may be configured to obtain information relating to the image acquisition system 100. For example, the acquisition module 310 may obtain a first exposure duration of a first image sensor and a second exposure duration of each of at least one second image sensor, the first image sensor and the at least one second image sensor being configured to shoot a target scene with different exposure durations. More descriptions regarding the obtaining of the first exposure duration and the second exposure duration of each of at least one second image sensor may be found elsewhere in the present disclosure. See, e.g., operation 410 in FIG. 4, and relevant descriptions thereof.

In some embodiments, the determination module 320 may be configured to determine, for each of the at least one second image sensor, a synchronization time difference between the first image sensor and the second image sensor based on an exposure duration difference between the first exposure duration and the second exposure duration of the second image sensor. the synchronization time difference may be smaller than the exposure duration difference. More descriptions regarding the determination of the synchronization time difference may be found elsewhere in the present disclosure. See, e.g., operation 420 in FIG. 4, and relevant descriptions thereof. In some embodiments, the determination module 320 may be configured to acquire, for each of the at least one second image sensor, first image data and second image data from the first image sensor and the second image sensor, respectively, by sending synchronizing signals to the first image sensor and the second image sensor based on the synchronization time difference. More descriptions regarding the acquisition of the first image data and second image data may be found elsewhere in the present disclosure. See, e.g., operation 430 in FIG. 4, and relevant descriptions thereof.

The generation module 330 may be configured to generate target image of the target scene based on the first image data of the first image sensor and the second image data of each second image sensor. More descriptions regarding the generation of the target image of the target scene may be found elsewhere in the present disclosure. See, e.g., operation 440 in FIG. 4, and relevant descriptions thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, any one of the modules may be divided into two or more units. For instance, the acquisition module 310 may be divided into two units configured to acquire different data. In some embodiments, the processing device 110 may include one or more additional modules, such as a storage module (not shown) for storing data.

FIG. 4 is a flowchart illustrating an exemplary process 400 for image acquisition according to some embodiments of the present disclosure. In some embodiments, the process 400 may be executed by the image acquisition system 100. For example, the process 400 may be implemented as a set of instructions stored in a storage device (e.g., the storage device 140 illustrated in FIG. 1A). In some embodiments, the processing device 110 may execute the set of instructions and may accordingly be directed to perform the process 400. The operations of the illustrated process presented below are intended to be illustrative. In some embodiments, the process 400 may be accomplished with one or more additional operations not described and/or without one or more of the operations discussed. Additionally, the order of the operations of process 400 illustrated in FIG. 4 and described below is not intended to be limiting.

In 410, the processing device 110 (e.g., the acquisition module 310) may obtain a first exposure duration of a first image sensor and a second exposure duration of each of at least one second image sensor, the first image sensor and the at least one second image sensor being configured to shoot a target scene with different exposure durations.

The first image sensor and the at least one second image sensor may be image sensors of the image acquisition device 130. The first image sensor and the at least one second image sensor may be configured to collect image data relating to the target scene. The image data may include an image, a video, and/or any related image data, such as values of one or more pixels (or referred to as pixel values) of an image (e.g., luma, gray values, intensities, chrominance, contrast of one or more pixels of an image), RGB data, audio information, timing information, location data, etc. Exemplary image sensors may include a charge-coupled device, a complementary metal-oxide-semiconductor transistor (CMOS) image sensor, or the like.

In some embodiments, the first image sensor and the at least one second image sensor may be same type or different types of image sensors. For example, the first image sensor and the at least one second image sensor may be CMOS image sensors.

In some embodiments, the first image sensor and the at least one second image sensor may be configured to sense different types of light. For example, the first image sensor is configured to sense one of infrared light and color light in the target scene, and the at least one second image sensor is configured to sense another of infrared light and color light in the target scene. The color light refers the ambient light in the target scene or the light obtained by filtering out the infrared light from the ambient light in target scene. For example, the light in the target scene may be separated into the infrared light and the color light (e.g., using light filters), and the infrared light and the color light may be input into the first image sensor and the at least one second image sensor, respectively. The image data collected by sensing the infrared light may be used to generate a monochrome image (also referred to as a black-and-white image). The image data collected by sensing the color light may be used to generate a color image.

In some embodiments, the shutters of the first image sensor and the at least one second image sensor may be rolling shutters. When a rolling shutter is used in image acquisition, different lines of a pixel array are exposed at different times. For example, the lines of the pixel array may be exposed line by line. In some embodiments, the shutters of the first image sensor and the at least one second image sensor may be global shutters. When a global shutter is used in image acquisition, different lines of a pixel array are exposed at the same time.

In some embodiments, field of views (FOVs) of the first image sensor and the at least one second image sensor may be the same, and the first image sensor and the at least one second image sensor may both be configured to shoot the entire target scene. For example, the first image sensor and the at least one second image sensor are used to sense different lights in the target scene, respectively. In some embodiments, the FOVs of the first image sensor and the at least one second image sensor may be different, and the first image sensor and the at least one second image sensor may configured to shoot different portions of the target scene. The FOVs of at least two adjacent image sensos of the first image sensor and the at least one second image sensor at least partially overlap for facilitating subsequent image fusion.

In some embodiments, an exposure duration of an image sensor (e.g., the first image sensor, a second image sensor) may be determined based on characteristics of a scene captured by the image sensor. The characteristics of the scene may include a brightness of the scene, whether there is a moving object in the scene, etc. For example, the greater the brightness of the scene, the shorter the exposure duration of the image sensor. As another example, if there is a moving object in the scene, the greater the moving speed of the moving object, the smaller the exposure duration of the image sensor. For example, if the image sensor is configured to shoot an object with a relatively high brightness or a relatively great moving speed, the exposure duration of the image sensor may be relatively small, such as 4 ms. If the image sensor is configured to shoot an object with a relatively low brightness or a relatively small moving speed, the exposure duration of the image sensor may be relatively great, such as 20 ms.

In some embodiments, the exposure duration of the image sensor may be determined by analyzing historical image data captured by the image sensor. For example, the exposure duration may be determined by analyzing the brightness of the latest image frame captured by the image sensor. A shorter exposure duration may be determined for the image sensor if the latest image frame has a high brightness. In some embodiments, the exposure duration may be previously determined, and stored in a storage device (e.g., the storage device 140 or an external device). The processing device 110 may obtain the exposure duration from the storage device.

In some embodiments, the image acquisition device 130 may include multiple image sensors with different exposure durations. Anyone of the image sensors may be designated as the first image sensor, and the other image sensor(s) of the image sensors may be designated as the second image sensor. The first image sensor may serve as a base image sensor, and the exposure manner of each second image sensor may be controlled based on the first image sensor.

In some embodiments, in order to ensure arcuate control of the second image sensor(s) and improve the imaging quality, the first image sensor may be selected from the multiple image sensors by data analyze. For example, the first image sensor may be selected by analyzing a region of interest (ROI) in the target scene. The ROI refers to an object whose characteristic changes in the target scene. Characteristics of an object may include a position, a brightness, etc., of the object. For example, a moving object in the target scene may be designated as an ROI. As another example, an object whose brightness changes in the target scene may be designated as an ROI.

Specifically, for each of the multiple image sensors, the processing device 110 may obtain historical image data captured by the image sensor. The historical image data refers to image data captured earlier than the current moment. For example, the historical image data include historical images captured by the image sensor in a preset historical time (e.g., 10 seconds, 20 seconds, 1 minutes, etc.). Further, for each of the multiple image sensors, the processing device 110 may determine relative position information of the image sensor to an ROI (also referred to as a first ROI) in the target scene based on the historical image data captured by the image sensor. For example, a distance from an image sensor to the ROI may be estimated based on the historical image data captured by the image sensor. Then, the processing device 110 may determine the first image sensor from the multiple image sensors based on the relative position information of each of the multiple image sensors to the ROI. For example, the processing device 110 may determine an image sensor with the minimum distance to the ROI from the multiple image sensors, and designate the image sensor as the first image sensor. In this way, it is more like that the first image sensor and the second image sensor can collect image data of the ROI simultaneously, thereby improving the imaging quality with respect to the ROI.

In some embodiments, the first image sensor may be selected by analyzing the exposure durations of the image sensors. Specifically, for each of the multiple image sensors, the processing device 110 may determine an exposure duration difference between an exposure duration of the image sensor and an exposure duration of each of the remaining image sensors of the multiple image sensors. Further, the processing device 110 may determine a total exposure duration difference corresponding to the image sensor by summing the exposure duration difference between the exposure duration of the image sensor and the exposure duration of each of the remaining image sensors of the multiple image sensors. Then, the processing device 110 may determine the first image sensor based on the total exposure duration differences corresponding to the multiple image sensors. For example, the processing device 110 may determine an image sensor with a minimum total exposure duration difference among the multiple image sensors, and designate the image sensor as the first image sensor. As described in operation 420, the synchronization time difference may be equal to half of the exposure duration difference, that is, the smaller the exposure duration difference, the smaller synchronization time difference. For two image sensors, the smaller the synchronization time difference between the two image sensors, the more conducive to the fusion of image data from the two image sensors, and more accurate fused image data may be obtained. Since the image sensor with the minimum total exposure duration difference among the multiple image sensors is designated as the first image sensor, a total synchronization time difference obtained by summing the synchronization time difference between the first image sensor and each of the remaining image sensors of the multiple image sensors (i.e., each second image sensor) may be a minimum total synchronization time difference. Therefore, this way is conducive to the fusion of the first image data of the first image sensor and the second image data of each second image sensor, thereby improving the accuracy of the target image described in operation 430.

In some embodiments, if there are a plurality of image sensors with the maximum total exposure duration difference, the processing device 110 may determine the first image sensor from the plurality of image sensors based on relative position information of each of the plurality of image sensors to the ROI. For example, the relative position information of an image sensor to the ROI may include a distance between the image sensor and the ROI. The processing device 110 may determine an image sensor with a minimum distance from the plurality of image sensors, and designate the image sensor as the first image sensor.

After the first image sensor is selected, the remaining image sensor(s) among the multiple image sensors may be designated the at least one second image sensor.

In 420, for each of the at least one second image sensor, the processing device 110 (e.g., the determination module 320) may determine, based on an exposure duration difference between the first exposure duration and the second exposure duration of the second image sensor, a synchronization time difference between the first image sensor and the second image sensor, wherein the synchronization time difference is smaller than the exposure duration difference.

The exposure duration difference of a second image sensor may be equal to the absolute value of the difference between the first exposure duration and the second exposure duration of the second image sensor.

The synchronization time difference between the first image sensor and a second image sensor refers a difference between a starting time for sending a synchronization signal to the first image sensor and a starting time for sending a synchronization signal to the second image sensor. A synchronizing signal is used to activate an image sensor (e.g., the first image sensor, or the second image sensor) to begin the exposure. In some embodiments, the synchronizing signal may be sent to the image sensor continuously until the exposure duration of the image sensor ends. Since the image sensor immediately begins the exposure after receiving the synchronizing signal, the start exposure time of the image sensor may be substantially the same as the starting time for sending the synchronizing signal to the image sensor. The synchronization time difference between the first image sensor and the second image sensor may be (or substantially) equal to a difference between the start exposure times of the first image sensor and the second image sensor.

In some embodiments, a difference between end exposure times of the first image sensor and the second image sensor may be smaller than the exposure duration difference.

In some embodiments, the synchronization time difference may be equal to half of the exposure duration difference. In such cases, both the difference between the end exposure times and the difference between the start exposure times may be equal to the synchronization time difference (i.e., half of the exposure duration difference). In some embodiments, the start exposure time and the end exposure time of an image sensor may be a pixel reset time and a pixel readout time, respectively.

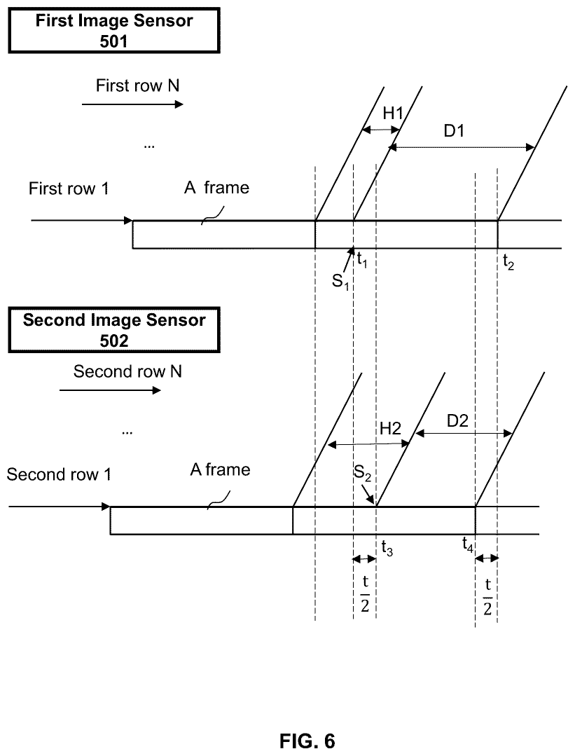

For example, FIG. 6 is a schematic diagram illustrating an exemplary exposure way of the first image sensor 501 and the second image sensor 502 during an image acquisition process according to some embodiments of the present disclosure. The first image sensor 501 and the second image sensor 502 include the same number of pixel rows. In FIG. 6, D1 represents the first exposure duration of the first image sensor 501, t₁ represents the staring time for sending a first synchronizing signal S1 to the first image sensor 501 and the starting exposure time of the first image sensor 501, t₂ represents the end exposure time of the first image sensor 501; D2 represents the second exposure duration of the second image sensor 502, t₃ represents the staring time for sending a second synchronizing signal S2 to the second image sensor 502 and the starting exposure time of the second image sensor 502, t₄ represents the end exposure time of the second image sensor 502; and t represents the exposure duration difference between the first exposure duration D1 and the second exposure duration D2. The synchronization time difference is equal to half of the exposure duration difference t (i.e., t/2). In such cases, both the difference between the end exposure times t₂ and t₄ and the difference between the start exposure times t₁ and t₃ are equal to t/2.

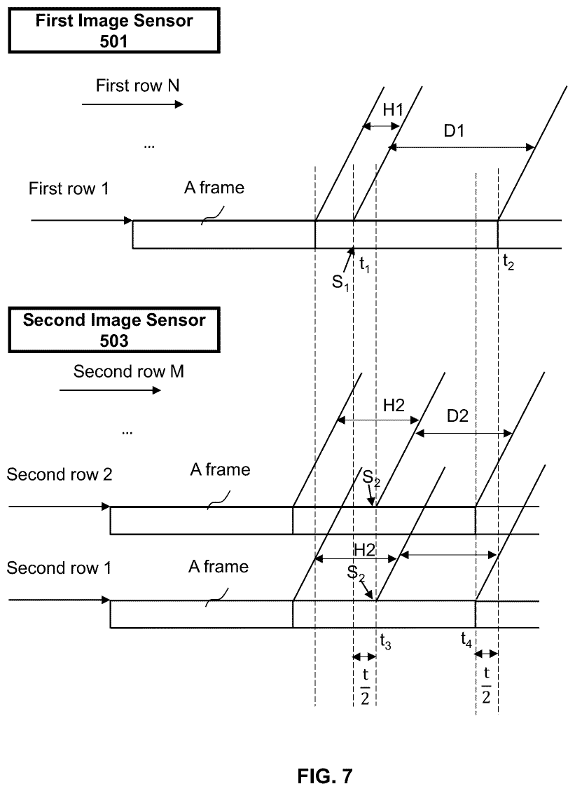

FIG. 7 is a schematic diagram illustrating an exemplary exposure way of the first image sensor 501 and another second image sensor 503 during an image acquisition process according to some embodiments of the present disclosure. The first image sensor 501 and the second image sensor 503 include different numbers of pixel rows. The exposure way in FIG. 7 is similar to the exposure way in FIG. 6, expect that multiple second synchronizing signals S2 corresponding to multiple second rows of the second image sensor 503 are sent at t₃.

As described elsewhere in the present disclosure, the conventional exposure ways have the problems of poor imaging quality, specifically for moving objects or objects with changing brightness. In the embodiments of the present disclosure, each image sensor can collect image data with its corresponding optimal exposure duration, so that each image sensor may collect clear image data. Moreover, by setting the synchronization time difference smaller than the exposure duration difference, the duration in which part of the image sensors are not exposing can be dispersed, thereby improving the clarity or accuracy of the target image. For example, referring to FIG. 6, when the synchronization time difference is equal to half of the exposure duration difference, the duration in which the second image sensor 502 is not exposing can be divided into two sub-durations before and after the second image sensor is not exposing.

On the one hand, centers of the first exposure duration of the first image sensor and the second exposure duration of the second image sensor are coincide, which may facilitate to the fusion of the first image data and the second image data. On the other hand, when an ROI (e.g., a moving object or an object with changing brightness) occurs in the target scene, it is more like that the first image sensor and the second image sensor can collect image data of the ROI simultaneously, thereby improving the imaging quality with respect to the ROI. Therefore, compared with the conventional exposure ways, the exposure ways disclosed herein have an improved imaging quality, especially for moving objects and objects with changing brightness.

In 430, for each of the at least one second image sensor, the processing device 110 (e.g., the determination module 320) may acquire first image data and second image data from the first image sensor and the second image sensor, respectively, by sending synchronizing signals to the first image sensor and the second image sensor based on the synchronization time difference.

As used herein, a synchronizing signal is used to activate an image sensor (e.g., the first image sensor, or the second image sensor) to begin the exposure. When an image sensor (e.g., the first image sensor, or the second image sensor) receives the synchronization signal, the image sensor immediately starts the exposure.

In some embodiments, the first image sensor may have a first pixel array that includes N first rows. The at least one second image sensor may include a second image sensor having a second pixel array that includes M second rows. The synchronizing signals include N first synchronizing signals corresponding to the N first rows and M second synchronizing signals corresponding to the M second rows. Specifically, for each first row, the processing device 110 may send a first synchronizing signal to the first row to direct the first row to perform the exposure. For each second row, the processing device 110 may send a second synchronizing signal to the second row to direct the second row to perform the exposure.

In some embodiments, N is equal to M, and a transmission time difference between the first synchronizing signal of the i^{th} first row and the second synchronizing signal of the i^{th} second row may be equal to the synchronization time difference. As used herein, i denotes a serial number of a first row or a second row. The processing device 110 may send the first synchronizing signal of the i^{th} first row and the second synchronizing signal of the i^{th} second row according to the transmission time difference.

For example, as shown in FIG. 6, the transmission time difference between the first synchronizing signal S1 of the first row 1 and the second synchronizing signal S2 of the second row 1 is equal to the synchronization time difference t/2. Specifically, for each frame, the processing device 110 may determine a first time interval H1 of the first image sensor and a second time interval H2 of the second image sensor. The first time interval H1 is equal to a duration of the frame minus the first exposure duration D1, and the second time interval H2 is equal to the duration of the frame minus the second exposure duration D2. For the first row 1 and the second row 1, at the end of the first time interval H1, the processing device 110 may send the first synchronizing signal S1 corresponding to the first row 1. Then, the processing device 110 may send the second synchronizing signal S2 corresponding to the second row 1 after the duration t/2 elapsed.

The first synchronizing signals corresponding to different first rows are sent to the first image sensor 501 in sequence so that the first rows of the first image sensor 501 are exposed line by line. Similarly, the second synchronizing signals corresponding to different second rows are sent to the second image sensor 502 in sequence so that the second rows of the second image sensor 502 are exposed line by line. For the i^{th} first row of the first image sensor 501 and the i^{th} second row of the second image sensor 502, their corresponding synchronizing signals are sent successively with a time delay of t/2.

In some embodiments, N is different from M. The processing device 110 may determine a proportionality coefficient based on N and M. In some embodiments, the proportionality coefficient may be determined according to N and M using a ceiling operation. Specifically, when M is smaller than N, the proportionality coefficient is equal to ┌N/M┐ when M is greater than N, the proportionality coefficient is equal to ┌M/N┐, wherein ┌ ┐ denotes the ceiling operation. For example, if the N and M are equal 10 and 6, respectively, the proportionality coefficient is equal to

$$⌈ \frac{10}{6} ⌉ = 2 .$$

Further, the processing device 110 may determine a corresponding relationship between the first rows of the first pixel array and the second rows of the second pixel array based on the proportionality coefficient. Specifically, when N is smaller than M, each first row of the first pixel array may correspond to multiple second rows of the second pixel array, and the count of the multiple second rows is equal to the proportionality coefficient; when M is smaller than N, multiple first rows of the first pixel array may correspond to one second row of the second pixel array, and the count of the multiple first rows is equal to the proportionality coefficient. For illustration purposes, an exemplary embodiment in which N is smaller than M is described. Specifically, when N is smaller than M, the i^{th} first row corresponds to the ((i−1)*r+1)^{th} second row to the (i*r)^{th} second row. For example, as shown in FIG. 7, the proportionality coefficient is 2, each first row of the first pixel array corresponds to two second rows of the second pixel array. The i^{th} first row corresponds to the ((i−1)*2+1)^{th} second row to the (i*2)^{th} second row. Merly by way of example, the first row 1 corresponds to the second rows 1 and 2.

Then, the processing device 110 may send the N first synchronizing signals and the M second synchronizing signals based on the corresponding relationship and the synchronization time difference. In some embodiments, a transmission time difference between the first synchronizing signal of the i^{th} first row and the second synchronizing signal of each second row corresponding to the i^{th} first row may be equal to the synchronization time difference. For example, as shown in FIG. 7, the transmission time difference between the first synchronizing signal S1 of the first row 1 and the second synchronizing signal S2 of the second row 1 is equal to the synchronization time difference t/2. The transmission time difference between the first synchronizing signal S1 of the first row 1 and the second synchronizing signal S2 of the second row 2 is also equal to the synchronization time difference t/2.

In some embodiments, for each frame, the first image sensor may collect first light information during the first exposure duration, and each second image sensor may collect second light information during the second exposure duration. The first image sensor may generate the first image data based on the first light information, and each second image sensor may generate the second image data based on the second light information. For example, light signals in the first light information and the second light information are converted into electric signals (e.g., charges) using A/D converters to generate the first image data and the second image data. If the light signal is stronger, more pairs of charges are converted.

In 440, the processing device 110 (e.g., the generation module 330) may generate target image of the target scene based on the first image data of the first image sensor and the second image data of each second image sensor.

In some embodiments, the processing device 110 may generate the target image data by fusing the first image data and the second image data of each second image sensor using an image fusion algorithm. Exemplary image fusion algorithms may include a pixel-level image fusion algorithm, a feature-level image fusion algorithm, a decision-level image fusion algorithm, or the like, or any combination thereof.

In some embodiments, the processing device 110 may perform one or more preprocessing operations on the first image data and the second image data, and further generate the target image by fusing the preprocessed first image data and the preprocessed second image data using the image fusion algorithm. Exemplary preprocessing operations may include an image registration, a haze removal operation, a color filtering operation, a noise reduction operation, etc. For example, for a visible light image generated based on color light in the target scene, the haze removal operation and the color filtering operation may be performed on the visible light image. As another example, the image registration and the noise reduction operation may be performed on the first image data and the second image data. Exemplary noise reduction operations may include a spatial filtering, a frequency domain filtering, or the like, or a combination thereof. The spatial filtering performed based on pixels of the image may include a linear filtering (e.g., a mean filtering, a Gaussian filtering, a Wiener filtering, etc.) and a non-linear filtering (e.g., a median filtering, etc.).

In some embodiments, after the first image data and the second image data (or the preprocessed first image data and the preprocessed second image data) are fused, the processing device 110 may perform a post-processing operation (e.g., an image enhancement operation) on the fused image data to generate the target image. Exemplary image enhancement operations may include a grayscale transformation enhancement, a linear grayscale enhancement, or the like, or any combination thereof.

Merly by way of example, the processing device 110 may perform the noise reduction operation on the first image data to generate denoised first image data. The processing device 110 may also perform the noise reduction operation on the second image data of each second image sensor to generate denoised second image data. Further, the processing device 110 may generate third image data by fusing the denoised first image data and the denoised second image data of each second image sensor. Then, the processing device 110 generate the target image by enhancing the third image data.

It should be noted that the process 400 and the descriptions thereof are provided for the purposes of illustration, and not intended to limit the scope of the present disclosure. For persons having ordinary skills in the art, various modifications and changes in the forms and details of the application of the above method and system may occur without departing from the principles of the present disclosure. However, those variations and modifications also fall within the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an subject oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate a certain variation (e.g., +1%, +5%, +10%, or +20%) of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable. In some embodiments, a classification condition used in classification or determination is provided for illustration purposes and modified according to different situations. For example, a classification condition that “a value is greater than the threshold value” may further include or exclude a condition that “the probability value is equal to the threshold value.”

1. A method for image acquisition implemented on a computing device having at least one processor and at least one storage device, the method comprising:
obtaining a first exposure duration of a first image sensor and a second exposure duration of each of at least one second image sensor, the first image sensor and the at least one second image sensor being configured to shoot a target scene with different exposure durations;
for each of the at least one second image sensor,
determining, based on an exposure duration difference between the first exposure duration and the second exposure duration of the second image sensor, a synchronization time difference between the first image sensor and the second image sensor, wherein the synchronization time difference is smaller than the exposure duration difference;
acquiring first image data and second image data from the first image sensor and the second image sensor, respectively, by sending synchronizing signals to the first image sensor and the second image sensor based on the synchronization time difference;
generating a target image of the target scene based on the first image data of the first image sensor and the second image data of each second image sensor.

2. The method of claim 1, wherein the synchronization time difference is equal to half of the exposure duration difference.

3. The method of claim 1, wherein for each of the at least one second image sensor,
a difference between start exposure times of the first image sensor and the second image sensor is smaller than the exposure duration difference.

4. The method of claim 1, wherein the first image sensor is configured to sense one of infrared light and color light in the target scene, and the at least one second image sensor is configured to sense another of infrared light and color light in the target scene.

5. The method of claim 1, wherein the generating a target image of the target scene based on the first image data of the first image sensor and the second image data of each second image sensor comprises:
performing a noise reduction operation on the first image data to generate denoised first image data;
performing a noise reduction operation on the second image data of each second image sensor to generate denoised second image data;
generating third image data by fusing the denoised first image data and the denoised second image data of each second image sensor; and
generating the target image by enhancing the third image data.

6. The method of claim 1, wherein the first image sensor is determined from multiple image sensors with different exposure durations by:
for each of the multiple image sensors,
obtaining historical image data captured by the image sensor;
determining relative position information of the image sensor to a region of interest (ROI) in the target scene based on the historical image data; and
determining the first image sensor from the plurality of sensors based on the relative position information of each of the multiple image sensors to the ROI.

7. The method of claim 1, wherein the first image sensor is determined from multiple image sensors with different durations by:
for each of the multiple image sensors,
determine an exposure duration difference between an exposure duration of the image sensor and an exposure duration of each of the remaining image sensors of the multiple image sensors;
determine a total exposure duration difference corresponding to the image sensor by summing the exposure duration difference between the exposure duration of the image sensor and the exposure duration of each of the remaining image sensors of the multiple image sensors; and
determining, based on the total exposure duration differences corresponding to the multiple image sensors, the first image sensor.

8. The method of claim 1, wherein
the first image sensor has a first pixel array that includes N first rows;
the at least one second image sensor includes a second image sensor having a second pixel array that includes M second rows,
the synchronizing signals include N first synchronizing signals corresponding to the N first rows and M second synchronizing signals corresponding to the M second rows.

9. The method of claim 8, wherein N is equal to M, and a transmission time difference between the first synchronizing signal of the i^{th} first row and the second synchronizing signal of the i^{th} second row is equal to the synchronization time difference.

10. The method of claim 8, wherein N is different from M, and the sending synchronizing signals to the first image sensor and the second image sensor based on the synchronization time difference comprises:
determining a proportionality coefficient based on N and M;
determining a corresponding relationship between the first rows of the first pixel array and the second rows of the second pixel array based on the proportionality coefficient; and
sending the N first synchronizing signals and the M second synchronizing signals based on the corresponding relationship and the synchronization time difference.

11. The method of claim 10, wherein
when N is smaller than M, each first row of the first pixel array corresponds to multiple second rows of the second pixel array, the count of the multiple second rows is equal to the proportionality coefficient,
when M is smaller than N, multiple first rows of the first pixel array correspond to one second row of the second pixel array, the count of the multiple first rows is equal to the proportionality coefficient, and
a transmission time difference between the first synchronizing signal of the i^{th} first row and the second synchronizing signal of each second row corresponding to the i^{th} first row is equal to the synchronization time difference.

12. A system for image acquisition, comprising:
at least one storage device including a set of instructions for medical imaging; and
at least one processor in communication with the at least one storage device, wherein when executing the set of instructions, the at least one processor is configured to direct the system to perform operations including:
obtaining a first exposure duration of a first image sensor and a second exposure duration of each of at least one second image sensor, the first image sensor and the at least one second image sensor being configured to shoot a target scene with different exposure durations;
for each of the at least one second image sensor,
determining, based on an exposure duration difference between the first exposure duration and the second exposure duration of the second image sensor, a synchronization time difference between the first image sensor and the second image sensor, wherein the synchronization time difference is smaller than the exposure duration difference;
acquiring first image data and second image data from the first image sensor and the second image sensor, respectively, by sending synchronizing signals to the first image sensor and the second image sensor based on the synchronization time difference;
generating a target image of the target scene based on the first image data of the first image sensor and the second image data of each second image sensor.

13. The system of claim 12, wherein the synchronization time difference is equal to half of the exposure duration difference.

14. The system of claim 12, wherein for each of the at least one second image sensor,
a difference between start exposure times of the first image sensor and the second image sensor is smaller than the exposure duration difference.

15. The system of claim 12, wherein the first image sensor is configured to sense one of infrared light and color light in the target scene, and the at least one second image sensor is configured to sense another of infrared light and color light in the target scene.

16. The system of claim 12, wherein the generating a target image of the target scene based on the first image data of the first image sensor and the second image data of each second image sensor comprises:
performing a noise reduction operation on the first image data to generate denoised first image data;
performing a noise reduction operation on the second image data of each second image sensor to generate denoised second image data;
generating third image data by fusing the denoised first image data and the denoised second image data of each second image sensor; and
generating the target image by enhancing the third image data.

17. The system of claim 12, wherein the first image sensor is determined from multiple image sensors with different exposure durations by:
for each of the multiple image sensors,
obtaining historical image data captured by the image sensor;
determining relative position information of the image sensor to a region of interest (ROI) in the target scene based on the historical image data; and
determining the first image sensor from the plurality of sensors based on the relative position information of each of the multiple image sensors to the ROI.

18. The system of claim 12, wherein the first image sensor is determined from multiple image sensors with different durations by:
for each of the multiple image sensors,
determine an exposure duration difference between an exposure duration of the image sensor and an exposure duration of each of the remaining image sensors of the multiple image sensors;
determine a total exposure duration difference corresponding to the image sensor by summing the exposure duration difference between the exposure duration of the image sensor and the exposure duration of each of the remaining image sensors of the multiple image sensors; and
determining, based on the total exposure duration differences corresponding to the multiple image sensors, the first image sensor.

19. The system of claim 12, wherein
the first image sensor has a first pixel array that includes N first rows;
the at least one second image sensor includes a second image sensor having a second pixel array that includes M second rows,
the synchronizing signals include N first synchronizing signals corresponding to the N first rows and M second synchronizing signals corresponding to the M second rows.

20-23. (canceled)

24. A non-transitory computer readable medium, comprising at least one set of instructions, wherein when executed by one or more processors of a computing device, the at least one set of instructions causes the computing device to perform a method, the method comprising:
obtaining a first exposure duration of a first image sensor and a second exposure duration of each of at least one second image sensor, the first image sensor and the at least one second image sensor being configured to shoot a target scene with different exposure durations;
for each of the at least one second image sensor,
determining, based on an exposure duration difference between the first exposure duration and the second exposure duration of the second image sensor, a synchronization time difference between the first image sensor and the second image sensor, wherein the synchronization time difference is smaller than the exposure duration difference;
acquiring first image data and second image data from the first image sensor and the second image sensor, respectively, by sending synchronizing signals to the first image sensor and the second image sensor based on the synchronization time difference;
generating a target image of the target scene based on the first image data of the first image sensor and the second image data of each second image sensor.

25. (canceled)
